(19) United States
(12) Patent Application Publication
(10) Pub. No.: US 2025/0271849 A1
(43) Pub. Date: Aug. 28, 2025

(54) DEVICE

(71) Applicant: TOYOTA JIDOSHA KABUSHIKI KAISHA, Toyota-shi (JP)

(72) Inventors: Kento IWAHORI, Nagoya-shi (JP); Daiki YOKOYAMA, Miyoshi-shi (JP); Jyunya KATOU, Toyota-shi (JP); Kosei MINAMI, Toyota-shi (JP)

(73) Assignee: TOYOTA JIDOSHA KABUSHIKI KAISHA, Toyota-shi (JP)

(21) Appl. No.: 19/001,446

(22) Filed: Dec. 25, 2024

(30) Foreign Application Priority Data
Feb. 28, 2024 (JP) 2024-028020

(51) Int. Cl. G05D 1/221; G05D 1/65; G05D 1/69; G05D 1/86; G05D 107/70; G05D 109/10

(52) U.S. Cl. CPC G05D 1/221; G05D 1/65; G05D 1/69; G05D 1/86; G05D 2107/70; G05D 2109/10

(57) ABSTRACT

The device includes: a identifying unit that specifies a corresponding moving body to which a defective component evacuated from a component line through which a plurality of components flow is assembled among one or more moving bodies moving the manufacturing line by unmanned operation, wherein the component line merges with the manufacturing line in an assembly area for performing assembly of the component to the moving body; an evacuation instruction for evacuating the corresponding moving body from the manufacturing line by unmanned operation; and an instruction unit that issues at least one of a skip instruction for skipping assembly of the corresponding moving body.

### CROSS-REFERENCE TO RELATED APPLICATION

This application claims priority to Japanese Patent Application No. 2024-028020 filed on Feb. 28, 2024, incorporated herein by reference in its entirety.

### BACKGROUND

### 1. Technical Field

The present disclosure relates to a device.

### 2. Description of Related Art

Japanese Unexamined Patent Application Publication (Translation of PCT Application) No. 2017-538619 (JP 2017-538619 A) discloses technology for causing a vehicle to travel by unmanned driving in a manufacturing process of the vehicle.

### SUMMARY

In an assembly area for assembling components to moving bodies such as vehicles, a technology is known in which the moving bodies and the components are merged, and the moving bodies and the components that are merged are assembled. Now, it is conceivable to transport the moving body to the assembly area by unmanned driving. However, appropriately executing assembly, when a component to be assembled to a moving body that is transported by unmanned driving has a defect, has not been studied.

The present disclosure can be realized as the following aspects.
(1) According to a first aspect of the present disclosure, a device is provided. This device includes an identifying unit that identifies, out of one or more moving bodies that move over a manufacturing line by unmanned driving, a relevant moving body to which a defective component that was evacuated from a component line, over which a plurality of components flows, is to be assembled, in which the component line merges with the manufacturing line in an assembly area for executing assembly of the component to the moving body, and an instruction unit for issuing at least one of an evacuation instruction for evacuating the relevant moving body from the manufacturing line by the unmanned driving, and a skip instruction for skipping the assembling to the relevant moving body. According to this aspect, an incorrect component can be suppressed from being assembled to the moving body in the assembly area, and assembly in the assembly area can be appropriately executed.
(2) In the above aspect, when the evacuation instruction is issued, the instruction unit may issue a first entry instruction for instructing equipment that is configured to change a position of each of the components flowing over the component line, to cause to enter, into a first vacant region generated by the defective component being removed from the component line, the component trailing the defective component, and a second entry instruction for instructing a trailing moving body that is the moving body trailing the relevant moving body, to enter a second vacant region generated by the relevant moving body being removed from the manufacturing line. According to this aspect, each component can be efficiently moved on the component line, and also each moving body can be efficiently moved on the manufacturing line, and accordingly, assembly can be executed more efficiently in the assembly area.
(3) In the above aspect, the instruction unit may cause the trailing moving body to enter the second vacant region by making a degree of deceleration of the trailing moving body to be smaller than a degree of deceleration of the moving body preceding the trailing moving body, in the second entry instruction. According to this aspect, a work process executed upstream of the assembly area in the manufacturing line can be suppressed from being affected by speed of the moving body being high, in comparison with when entering the moving body to the vacant region by further accelerating the trailing moving body.
(4) In the above aspect, the instruction unit may issue an instruction to repair a defect of the defective component that was evacuated, and when repair of the defect is complete, issue an instruction for causing equipment that is configured to enter a repaired component that is the component regarding which the repair is completed to the component line, to enter the repaired component to the component line, and an instruction for causing the relevant moving body evacuated by the evacuation instruction to enter the manufacturing line by the unmanned driving. According to this aspect, the repaired component can be returned to the component line and the relevant moving body can be returned to the manufacturing line, without manual work.
(5) In the above aspect, the instruction unit may issue an instruction to repair a defect of the defective component that was evacuated, and when repair of the defect is complete, issue an instruction for moving a repaired component that is the component regarding which the repair is completed, toward the relevant moving body using a device different from the component line, and an instruction for assembling the repaired component to the relevant moving body. According to this aspect, the repaired component can be assembled to the relevant moving body without entering the repaired component to the component line again. The present disclosure can also be realized in a form of, for example, a moving body, a system, a method of manufacturing the moving body, a method of controlling the moving body, a program, a non-transitory recording medium in which the program is recorded, a program product, and so forth, in addition to the form of a device that is described above. Note that the program product may also be provided as a storage medium that stores the program, or may be provided as a program product that can be distributed via a network, for example.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a conceptual diagram showing a configuration of a system according to a first embodiment;

FIG. 2 is a conceptual diagram illustrating component evacuation and component return;

FIG. 3 is a conceptual diagram illustrating a correspondence relationship between each vehicle and each component;

FIG. 4 is a block diagram illustrating a configuration of a system;

FIG. 5 is a flowchart illustrating a processing procedure of travel control of a vehicle according to the first embodiment;

FIG. 6 is a flowchart of a manufacturing process according to the first embodiment;

FIG. 7 is a diagram illustrating an example of a manufacturing process according to the first embodiment;

FIG. 8 is a block diagram illustrating a configuration of a system according to a second embodiment;

FIG. 9 is a flowchart of a manufacturing process according to the second embodiment;

FIG. 10 is a diagram illustrating an example of a manufacturing process according to the second embodiment;

FIG. 11 is a block-diagram illustrating a configuration of a system according to a third embodiment; and

FIG. 12 is a flowchart illustrating a processing procedure of travel control of the vehicle according to the third embodiment.

### DETAILED DESCRIPTION OF EMBODIMENTS

### A. First Embodiment

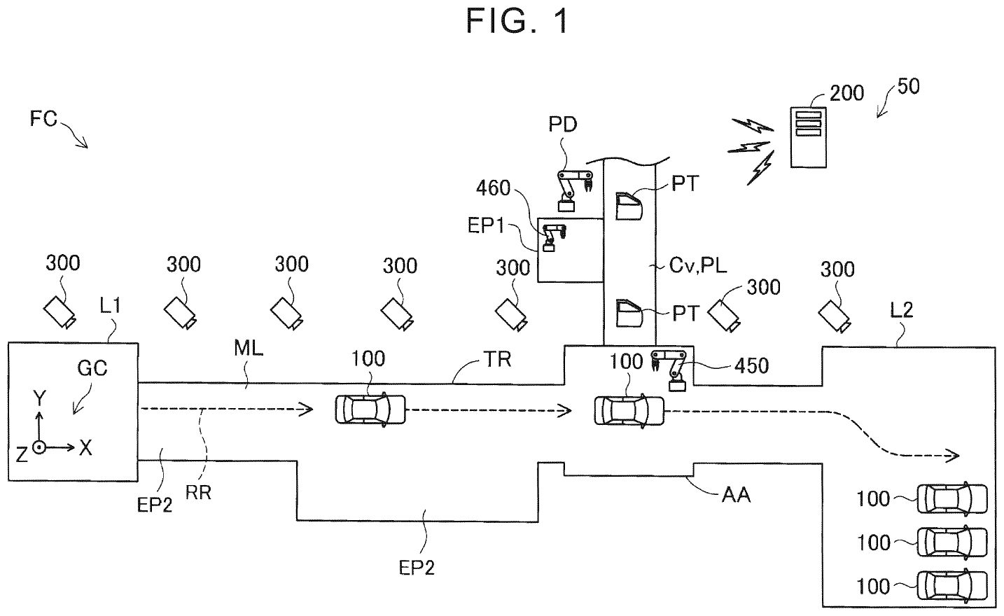

FIG. 1 is a conceptual diagram illustrating a configuration of a system 50 according to a first embodiment. The system 50 includes one or more vehicles 100 as moving bodies, a server 200, and one or more external sensors 300. The server 200 in the first embodiment corresponds to a “device” in the present disclosure.

In the present disclosure, “moving body” means a movable object, and is, for example, a vehicle or an electric vertical takeoff and landing machine (a so-called flying vehicle). The vehicle may be a vehicle traveling by a wheel or a vehicle traveling by an infinite track, and is, for example, a passenger car, a truck, a bus, a two-wheeled vehicle, a four-wheeled vehicle, a tank, a construction vehicle, or the like. Vehicles include battery electric vehicle (BEV: Battery Electric Vehicle), gasoline-powered vehicles, hybrid electric vehicle, and fuel cell electric vehicle. When the moving body is other than the vehicle, the expressions of “vehicle” and “vehicle” in the present disclosure can be appropriately replaced with “moving body”, and the expression of “traveling” can be appropriately replaced with “moving”.

The vehicle 100 is configured to be able to travel by unmanned driving. The term “unmanned driving” means driving that does not depend on the traveling operation of the passenger. The traveling operation means an operation related to at least one of “running”, “turning”, and “stopping” of the vehicle 100. The unmanned driving is realized by automatic or manual remote control using a device located outside the vehicle 100 or by autonomous control of the vehicle 100. A passenger who does not perform the traveling operation may be on the vehicle 100 traveling by the unmanned driving. The passenger who does not perform the traveling operation includes, for example, a person who is simply seated on the seat of the vehicle 100 and a person who performs a work different from the traveling operation such as an assembling operation, an inspection operation, and an operation of switches while riding on the vehicle 100. Driving by the traveling operation of the occupant is sometimes referred to as “manned driving”.

Herein, “remote control” includes “full remote control” in which all of the operations of the vehicle 100 are completely determined from the outside of the vehicle 100, and “partial remote control” in which a part of the operations of the vehicle 100 is determined from the outside of the vehicle 100. Further, “autonomous control” includes “fully autonomous control” in which the vehicle 100 autonomously controls its operation without receiving any information from a device external to the vehicle 100, and “partially autonomous control” in which the vehicle 100 autonomously controls its operation using information received from a device external to the vehicle 100.

The vehicle 100 may be provided with a configuration that can be moved by unmanned driving, and may be, for example, in the form of a platform having a configuration described below. Specifically, the vehicle 100 may include at least a vehicle control device and an actuator group, which will be described later, in order to perform three functions of “running”, “turning”, and “stopping” by unmanned driving. When information is acquired from a device outside the vehicle 100 for unmanned driving, the vehicle 100 may further include a communication device. That is, the vehicle 100 that can be moved by the unmanned driving may not be equipped with at least a part of an interior component such as a driver's seat or a dashboard. In addition, the vehicle 100 that can be moved by unmanned driving may not be equipped with at least a part of an exterior component such as a bumper or a fender. In addition, the vehicle 100 that can be moved by unmanned driving may not be equipped with the body shell. In this instance, the remaining components, such as the body shell, may be mounted to the vehicle 100 until the vehicle 100 is shipped from the factory FC. In addition, while the remaining components such as the body shell are not mounted on the vehicle 100, the remaining components such as the body shell may be mounted on the vehicle 100 after the vehicle 100 is shipped from the factory FC. Each of the components may be mounted from any direction, such as the upper side, lower side, front side, rear side, right side or left side of the vehicle 100, each may be mounted from the same direction, or may be mounted from a different direction.

In the present embodiment, the system 50 is used in a factory FC that manufactures the vehicles 100. The reference coordinate system of the factory FC is a global coordinate system GC, and any position in the factory FC can be represented by the coordinates of X, Y, Z in the global coordinate system GC. Vehicle 100 travels in a factory FC from a first location L1 to a second location L2 through a track TR on which vehicle 100 can travel by unmanned driving.

In the factory FC, a plurality of external sensors 300 are installed along the track TR. The external sensor 300 is a sensor located outside the vehicle 100. The external sensor 300 is constituted by a camera. The camera as the external sensor 300 captures an image of the vehicle 100 and outputs a captured image as a detection result. The external sensor 300 includes a communication device (not shown), and can communicate with another device such as the server 200 by wired communication or wireless communication. The positions of the external sensors 300 in the factory FC are adjusted in advance.

The factory FC has a manufacturing line ML and a component line PL. The manufacturing line ML and the component line PL merge in the assembly area AA. The manufacturing line ML is a line for transporting the vehicles 100 by unmanned driving. In the present embodiment, a part of the track TR corresponds to the manufacturing line ML. The component line PL is a line for transporting a plurality of component PT. In the component line PL, each component PT to be assembled to each vehicle 100 to be manufactured in the factory FC flows. In the present embodiment, the conveyor device Cv for conveying the component PT toward the assembly area AA corresponds to the component line PL. The component line PL may be configured to be capable of sequentially conveying the component PT to the assembly area AA. In other embodiments, a line using a hanger that suspends and moves the component PT may be used, or a line using an automatic guided vehicle (AGV) that conveys the component PT may be used. In the assembly area AA, the assembly of the component PT to the vehicles 100 is performed. In the present embodiment, the assembly in the assembly-area AA is performed by the assembly robots 450. The assembly robots 450 are exemplary devices for assembling component PT to the vehicles 100.

In the present embodiment, the component processor PD is disposed in the vicinity of the component line PL. The component processor PD is configured by, for example, a robotic device. The component processor PD is configured to be capable of performing component evacuation and component return described later.

Vehicle 100 flowing through the manufacturing line ML is capable of vehicle evacuation and vehicle return. “Vehicle evacuation” means that the vehicle 100 is evacuated to the second evacuation location EP2 outside the manufacturing line ML. The second evacuation location EP2 is a location for evacuating the vehicles 100 from the manufacturing line ML. “Vehicle return” means that the vehicle 100 returns onto the manufacturing line ML. The second evacuation location EP2 may be, for example, a track aligned with the manufacturing line ML in the vehicle-width direction of the track TR or a track connected to the manufacturing line ML. In the present embodiment, vehicle evacuation and vehicle return are realized by traveling by the unmanned driving of the vehicle 100. In other embodiments, vehicle evacuation and vehicle return may be realized by, for example, a traveling operation by an operator, transportation by an operator or a robot using wheels of the vehicle 100, or transportation without wheels. Since the vehicle 100 is configured to be movable by unmanned driving, vehicle evacuation and vehicle return can be easily performed by traveling of the vehicle 100 or transporting the vehicle 100 on the track TR.

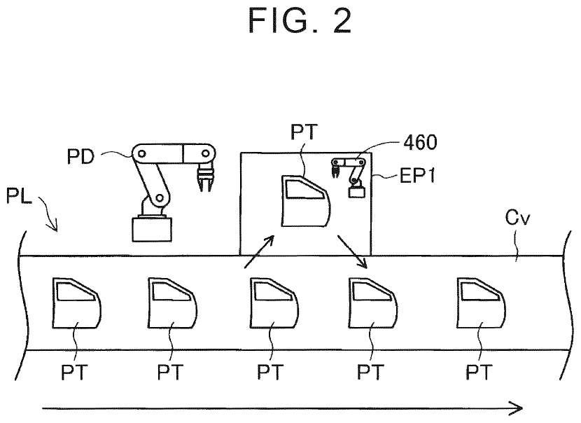

FIG. 2 is a conceptual diagram illustrating component evacuation and component return. As in the case of the vehicle 100, the component PT flowing through the component line PL can be evacuated and returned to the component. “Part evacuation” means that the component PT is evacuated to the first evacuation location EP1 outside the component line PL. The first evacuation location EP1 is a location for evacuating the component PT from the component line PL. In the present embodiment, a repair device 460, which will be described later, is disposed in the first evacuation location EP1. “Component return” means that the component PT returns onto the component line PL. In other embodiments, component evacuation or component return may be performed, for example, by an operator, rather than, for example, a component processor PD. Further, for example, a conveyor device Cv, a hanger, or a AGV used in the component line PL may be configured as a device capable of performing component evacuation or component return. Specifically, for example, when the component line PL is configured as a line using the conveyor device Cv as in the present embodiment, the component evacuation may be executed by changing the conveyance direction of the conveyor in the vicinity of the first evacuation location EP1. Further, a return conveyor may be laid on the first evacuation location EP1, and component return may be performed using the return conveyor.

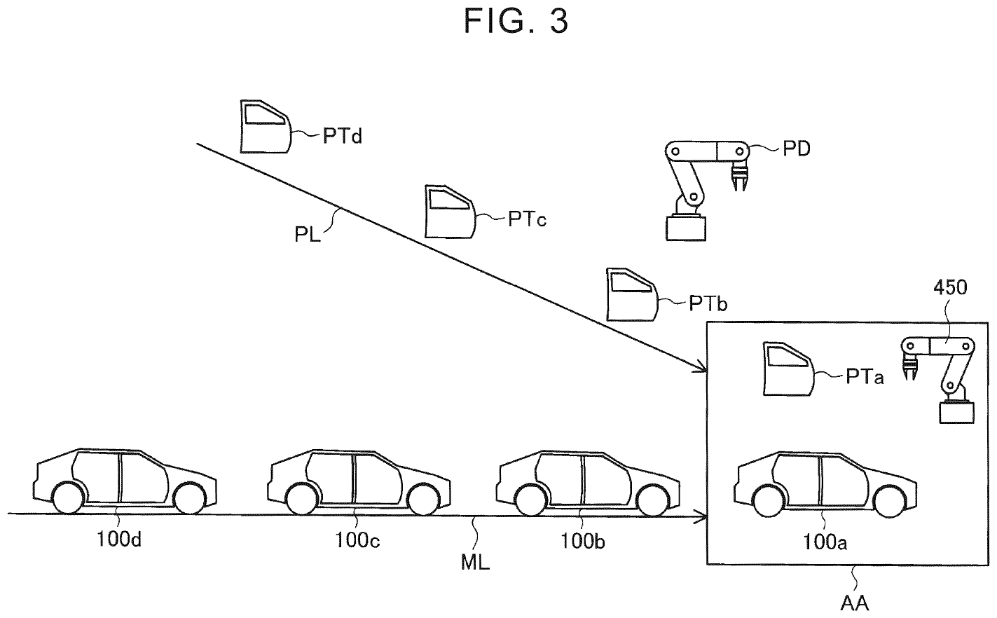

FIG. 3 is a conceptual diagram illustrating a correspondence relation between each vehicle 100 and each component PT in the component line PL in the manufacturing line ML. In the vehicle 100a, 100b, 100c, 100d illustrated in FIG. 3, component PTa, PTb, PTc, PTd corresponding to the respective vehicles 100 in a one-to-one manner are assembled. The correspondence between each vehicle 100 and each component PT is managed using, for example, the identification number of the vehicle 100. The vehicles 100 illustrated in FIG. 3 arrive at the assembly area AA in the order of vehicle 100a, 100b, 100c, 100d. The component PT illustrated in FIG. 2 arrive at the assembly area AA in the order of the component PTa, PTb, PTc, PTd corresponding to the arrival order of the vehicles 100.

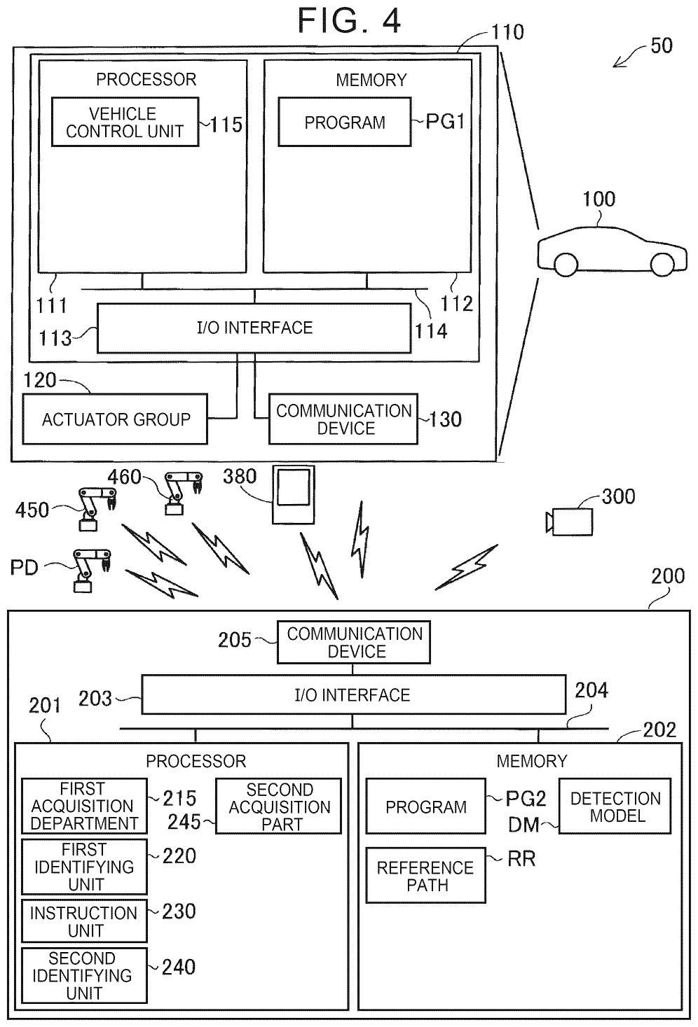

FIG. 4 is a block diagram illustrating a configuration of the system 50. The vehicle 100 includes a vehicle control device 110 for controlling each unit of the vehicle 100, an actuator group 120 including one or more actuators driven under the control of the vehicle control device 110, and a communication device 130 for wirelessly communicating with an external device such as the server 200. The actuator group 120 includes an actuator of a driving device for accelerating the vehicle 100, an actuator of a steering device for changing a traveling direction of the vehicle 100, and an actuator of a braking device for decelerating the vehicle 100.

The vehicle control device 110 includes a computer including a processor 111, a memory 112, an input/output interface 113, and an internal bus 114. The processor 111, the memory 112, and the input/output interface 113 are bidirectionally communicably connected via an internal bus 114. An actuator group 120 and a communication device 130 are connected to the input/output interface 113. The processor 111 executes the program PG1 stored in the memory 112 to realize various functions including functions as the vehicle control unit 115.

The vehicle control unit 115 controls the actuator group 120 to cause the vehicle 100 to travel. The vehicle control unit 115 can cause the vehicle 100 to travel by controlling the actuator group 120 using the travel control signal received from the server 200. The travel control signal is a control signal for causing the vehicle 100 to travel. In the present embodiment, the travel control signal includes the acceleration and the steering angle of the vehicle 100 as parameters. In other embodiments, the travel control signal may include the speed of the vehicle 100 as a parameter in place of or in addition to the acceleration of the vehicle 100.

The server 200 includes a computer including a processor 201, a memory 202, an input/output interface 203, and an internal bus 204. The processor 201, the memory 202, and the input/output interface 203 are bidirectionally communicably connected via an internal bus 204. A communication device 205 for communicating with various devices external to the server 200 is connected to the input/output interface 203. The communication device 205 can communicate with the vehicle 100 and the terminal device 380 of the user by wireless communication, and can communicate with the external sensors 300, the assembly robots 450, the repair device 460, and the component processor PD by wired communication or wireless communication. The user means a user of the system 50 or the factory FC, and is, for example, an administrator or an operator of the factory FC. The processor 201 executes the program PG2 stored in the memory 202 to realize various functions including functions as the first acquisition unit 215, the first identifying unit 220, the instruction unit 230, the second acquisition unit 245, and the second identifying unit 240. Note that the first identifying unit 220 is also simply referred to as an identifying unit.

The first acquisition unit 215 acquires defect information. The defect information is information related to a defect of the component PT flowing through the component line PL. Hereinafter, a component PT having a defect is also referred to as a defective component. For example, the first acquisition unit 215 may acquire the defect information by detecting the defect using the external sensor 300, or may acquire the defect information input by the user. The defect information may be transmitted to the server 200 via the terminal device 380, for example. The defect information may be, for example, information indicating that there is a defect, information indicating a portion having a defect in the component PT, or information indicating a type of a defect such as a mechanical defect, an electric defect, or an external defect.

When the defect data is acquired, the first identifying unit 220 specifies the corresponding vehicles corresponding to the defective components from among the plurality of component PT flowing in the component line PL. The corresponding vehicle is the vehicle 100 to which the defective component is assembled if the defective component does not have a defect. For example, the first identifying unit 220 specifies the corresponding vehicle by specifying the identification number of the corresponding vehicle and the order in the manufacturing line ML based on the identification number of the defective component and the order in the component line PL. In the present embodiment, the first identifying unit 220 specifies the corresponding vehicle in substantially the same manner as described above even when the completion information to be described later is acquired.

The instruction unit 230 in the present embodiment functions as a remote control unit as appropriate. The remote control unit generates a travel control signal and transmits a travel control signal to the vehicle 100 to cause the vehicle 100 to travel by remote control. The instruction unit 230 can also be said to issue a remote instruction for causing the vehicle 100 to travel by remote control to the vehicle 100.

The instruction unit 230 according to the present embodiment executes a component evacuation instruction and a vehicle evacuation instruction. Further, the instruction unit 230 in the present embodiment issues a component entry instruction, a vehicle entry instruction, a repair instruction, a component return instruction, and a vehicle return instruction. The vehicle evacuation instruction is also simply referred to as “evacuation instruction”. The component entry instruction is also referred to as a first entry instruction, and the vehicle entry instruction is also referred to as a second entry instruction.

The component evacuation instruction is an instruction for evacuating the defective component from the component line PL. In the component evacuation instruction according to the present embodiment, the instruction unit 230 transmits a control command for moving the defective component from the component line PL to the first evacuation location EP1 to the component processor PD.

The vehicle evacuation instruction is an instruction for evacuating the corresponding vehicle from the manufacturing line ML by an unmanned operation. In the vehicle evacuation instruction according to the present embodiment, the instruction unit 230 generates a travel control signal for causing the corresponding vehicle to travel to the outside of the manufacturing line ML, and transmits the travel control signal to the corresponding vehicle.

The component entry instruction is to instruct the device configured to change the position of the component PT flowing through the component line PL to enter the trailing component into the first vacant region. The trailing component is a trailing component PT of the defective component in the component line PL. The first vacant region is an area generated when a defective component is evacuated from the component line PL by a component evacuation instruction. That is, the first vacant region corresponds to an area originally occupied by the defective component on the component line PL. In the component entry instruction according to the present embodiment, the instruction unit 230 transmits a control command for moving the trailing component to the first vacant region to the component processor PD.

The vehicle entry instruction is to instruct the trailing vehicle to enter the second vacant region. The trailing vehicle is a trailing vehicle of the corresponding vehicle in the manufacturing line ML. The second vacant region is an area generated when the corresponding vehicle deviates from the manufacturing line ML according to the vehicle evacuation instruction. That is, the second vacant region corresponds to the area originally occupied by the corresponding vehicles on the manufacturing line ML. In the vehicle entry instruction according to the present embodiment, the instruction unit 230 generates a travel control signal for causing the trailing vehicle to enter the second vacant region, and transmits the travel control signal to the trailing vehicle. Further, in the present embodiment, the travel control signal generated in the vehicle entry instruction is a travel control signal for making the degree of deceleration of the trailing vehicle smaller than the degree of deceleration of the preceding vehicle. The preceding vehicle is the vehicle 100 preceding the trailing vehicle when the corresponding vehicle is evacuated. Specifically, when the preceding vehicle decelerates, the instruction unit 230 generates a travel control signal for preventing the deceleration of the trailing vehicle as compared with the preceding vehicle, and transmits the travel control signal to the trailing vehicle.

The repair instruction is an instruction for repairing a defect of a defective component. The repair instruction in the present embodiment is an instruction for causing a defective component to be repaired at a repair place. In the present embodiment, the first evacuation location EP1 corresponds to a repair location. Further, in the present embodiment, the repair instruction is issued to the repair device 460 for repairing the defect. Specifically, in the repair instruction, the instruction unit 230 transmits a control signal for causing the repair to be executed at the repair place to the repair device 460. The repair device 460 is constituted by, for example, a robot capable of repairing a defect. In other embodiments, the repair instruction may include, for example, an instruction for moving the defective component to the repair place.

The component return instruction is an instruction for causing the repaired component to enter the component line PL. The repaired part is a component PT in which the repair of the defect is completed, that is, the original defective component. The component return instruction is issued to a device configured to allow the repaired component to enter the component line PL. In the present embodiment, the component return instruction is issued to the component processor PD. Further, the component return instruction is executed when the repair of the defect of the defective component is completed. Specifically, in the present embodiment, the instruction unit 230 issues a component return instruction when the completion information is acquired. The completion information is information related to completion of repair of the defect of the defective component. As will be described later, the completion information is acquired by the second acquisition unit 245.

The vehicle return instruction is an instruction for causing the corresponding vehicle evacuated by the vehicle evacuation instruction to enter the manufacturing line ML by unmanned driving. More specifically, the vehicle return instruction is an instruction for causing the corresponding vehicle to enter the second return position on the manufacturing line ML. The second return position is a position corresponding to the first return position on the component line PL. The first return position is a position at which the repaired component returns to the component line PL according to the component return instruction. As will be described later, the second return position is specified by the second identifying unit 240. The vehicle return instruction is executed when the repair of the defect of the defective component is completed, similarly to the component return instruction. In the vehicle return instruction according to the present embodiment, the instruction unit 230 generates a travel control signal for causing the corresponding vehicle to travel to the second return position on the manufacturing line ML, and transmits the travel control signal to the corresponding vehicle.

The second acquisition unit 245 acquires the above-described completion information. The completion information may be transmitted to the server 200 via the terminal device 380, for example. In this case, for example, completion information is input to the terminal device 380 by the user. In addition, the completion information may be transmitted from the device in charge of repair of the defect, that is, for example, the repair device 460 to the server 200.

The second identifying unit 240 specifies the second return position according to the first return position. The second identifying unit 240 specifies the second position so that the corresponding vehicles arrive at the assembly area AA in accordance with the repaired component that returns from the first return position to the component line PL and is directed to the assembly area AA. That is, the second position is specified so that the corresponding vehicle arrives at the assembly area AA in the order and timing in which the assembly of the corresponding vehicle in the assembly area AA is correctly performed. In this way, in response to the repaired component being returned to the component line PL, the corresponding vehicle can be returned to the manufacturing line ML, and the assembly of the corresponding vehicle can be performed more smoothly in the assembly area AA. The first return position may be determined in advance according to, for example, the position of the repair place or the route from the component line PL to the repair place. Further, the second identifying unit 240 may specify the first return position using the external sensor 300, for example.

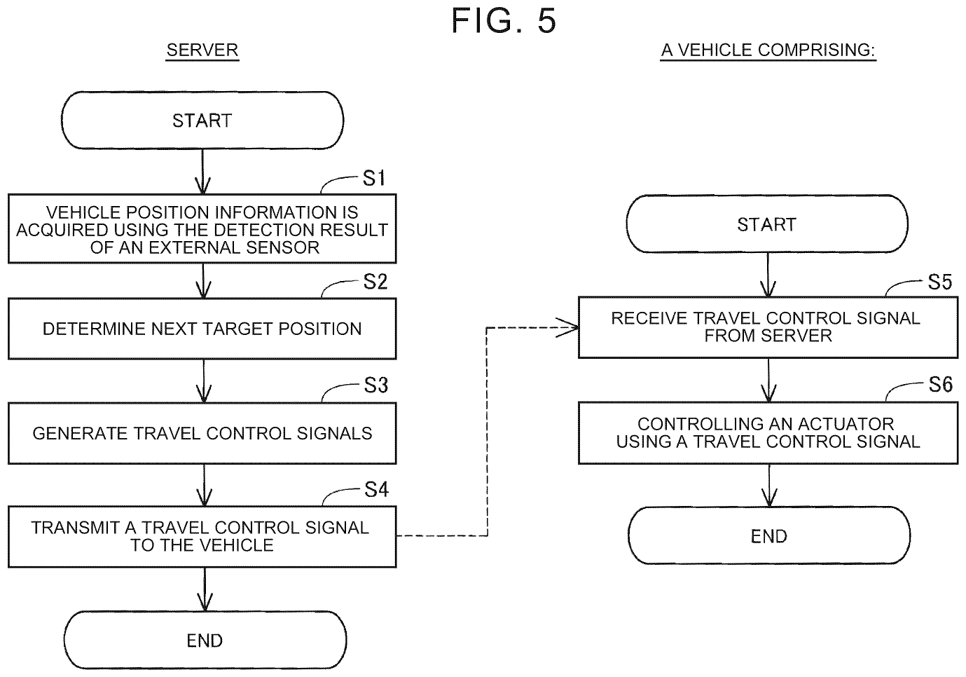

FIG. 5 is a flowchart illustrating a processing procedure of travel control of the vehicle 100 according to the first embodiment. In the process of FIG. 5, the processor 201 of the server 200 functions as a remote control unit by executing a program PG2. The processor 111 of the vehicle 100 functions as the vehicle control unit 115 by executing the program PG1.

In S1, the processor 201 of the server 200 acquires the vehicle position information using the detection result outputted from the external sensor 300. The vehicle position information is position information that is a basis for generating a travel control signal. In the present embodiment, the vehicle position information includes the position and orientation of the vehicle 100 in the global coordinate system GC of the factory FC. Specifically, in S1, the processor 201 acquires vehicle-position data using captured images acquired from cameras that are the external sensors 300.

Specifically, in S1, the processor 201 acquires the position of the vehicle 100 by, for example, detecting the outline of the vehicle 100 from the captured image, calculating the coordinate system of the captured image, that is, the coordinates of the positioning point of the vehicle 100 in the local coordinate system, and converting the calculated coordinates into the coordinates in the global coordinate system GC. The outline of the vehicle 100 included in the captured image can be detected by, for example, inputting the captured image into a detection model DM using artificial intelligence. The detection model DM is prepared in the system 50 or outside the system 50, for example, and stored in the memory 202 of the server 200 in advance. Examples of the detection model DM include a learned machine learning model that is learned so as to realize one of semantic segmentation and instance segmentation. As the machine learning model, for example, a convolutional neural network (hereinafter referred to as a CNN) learned by supervised learning using a learning dataset can be used. The training data set includes, for example, a plurality of training images including the vehicle 100 and a label indicating which of the regions in the training image indicates the vehicle 100 and the regions other than the vehicle 100. When CNN is learned, the parameters of CNN are preferably updated by back propagation so as to reduce the error between the output-result and-label due to the detection model DM. Further, the processor 201 can obtain the direction of the vehicle 100 by estimating the direction of the movement vector of the vehicle 100 calculated from the position change of the feature point of the vehicle 100 between the frames of the captured image using, for example, the optical flow method.

In S2, the processor 201 of the servers 200 determines the target location to which the vehicles 100 should be heading next. In the present embodiment, the target position is represented by the coordinates of X, Y, Z in the global coordinate system GC. In the memories 202 of the servers 200, reference path RR that is a route on which the vehicles 100 should travel is stored in advance. The route is represented by a node indicating a starting point, a node indicating a passing point, a node indicating a destination, and a link connecting the respective nodes. The processor 201 uses the vehicle position information and the reference path RR to determine the target position to which the vehicle 100 is to be directed next. The processor 201 determines the target position on the reference path RR ahead of the current position of the vehicles 100.

In S3, the processor 201 of the server 200 generates a travel control signal for causing the vehicle 100 to travel toward the determined target position. The processor 201 calculates the traveling speed of the vehicle 100 from the transition of the position of the vehicle 100, and compares the calculated traveling speed with the target speed. The processor 201 generally determines the acceleration so that the vehicle 100 accelerates when the travel speed is lower than the target speed, and determines the acceleration so that the vehicle 100 decelerates when the travel speed is higher than the target speed. In addition, the processor 201 determines the steering angle and the acceleration so that the vehicle 100 does not deviate from the reference path RR when the vehicle 100 is located on the reference path RR. Also, if the vehicle 100 is not located on the reference path RR, in other words, if the vehicle 100 deviates from the reference path RR, the processor 201 determines the steering angle and the acceleration so that the vehicle 100 returns to the reference path RR.

In S4, the processor 201 of the servers 200 transmits the generated travel control signal to the vehicles 100. The processor 201 repeats acquisition of vehicle position information, determination of a target position, generation of a travel control signal, transmission of a travel control signal, and the like at predetermined intervals.

In S5, the processor 111 of the vehicle 100 receives the travel control signal transmitted from the server 200. In S6, the processor 111 of the vehicle 100 controls the actuator group 120 using the received travel control signal, thereby causing the vehicle 100 to travel at the acceleration and the steering angle represented by the travel control signal. The processor 111 repeatedly receives the travel control signal and controls the actuator group 120 at a predetermined cycle. According to the system 50 of the present embodiment, the vehicle 100 can be driven by remote control, and the vehicle 100 can be moved without using a conveyance facility such as a crane or a conveyor.

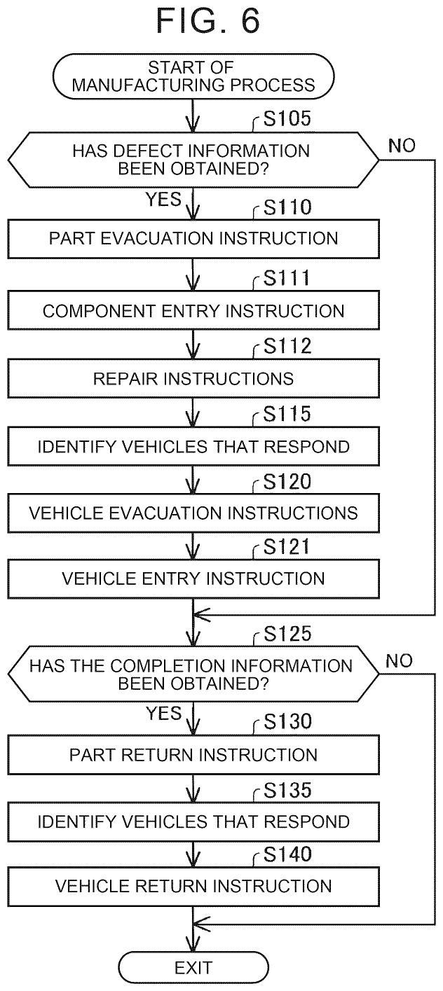

FIG. 6 is a flowchart of a manufacturing process for realizing the manufacturing method of the vehicle 100 according to the present embodiment. The processor 201 executes a manufacturing process at predetermined time intervals, for example.

In S105, the instruction unit 230 determines whether or not the first acquisition unit 215 has acquired the defect data. When the defect information is acquired in S105, at S110, the instruction unit 230 identifies the defective component based on the defect information, and issues a component evacuation instruction for the identified defective component to the component processor PD. The component processor PD to which the component evacuation instruction has been issued evacuates the defective component to the first evacuation location EP1. In S111, the instruction unit 230 issues a component entry instruction to the component processor PD. The component processor PD that has issued the component entry instruction causes the trailing component to enter the first vacant region R1. In S112, the instruction unit 230 issues a repair instruction to the repair device 460. The repair device 460 to which the repair instruction is issued repairs the defect of the defective component.

In S115, the first identifying unit 220 specifies the corresponding vehicles corresponding to the defective components to be evacuated by S110. In S120, the instruction unit 230 issues a vehicle evacuation instruction to the corresponding vehicle specified by S115. The vehicle control unit 115 of the corresponding vehicle travels to the second evacuation location EP2 by using the travel control signal transmitted by S120. In S121, the instruction unit 230 issues a vehicle entry instruction to the trailing vehicle. The vehicle control unit 115 of the trailing vehicle travels to the second vacant region R2 by using the travel control signal transmitted by S121.

In S125, the instruction unit 230 determines whether or not the completion information has been acquired by the second acquisition unit 245. When the completion information is acquired by S125, at S130, the instruction unit 230 identifies the repaired component based on the completion information, and issues a component restoration instruction for the identified repaired component to the component processor PD. The component processor PD that has issued the component return instruction returns the defective component from the first evacuation location EP1 to the component line PL. In S135, the first identifying unit 220 identifies the corresponding vehicles corresponding to the repaired components to be restored in S130. In S140, the instruction unit 230 issues a vehicle return instruction to the corresponding vehicle specified by S135. The vehicle control unit 115 of the corresponding vehicle travels from the second evacuation location EP2 to the manufacturing line ML by using the travel control signal transmitted by S140.

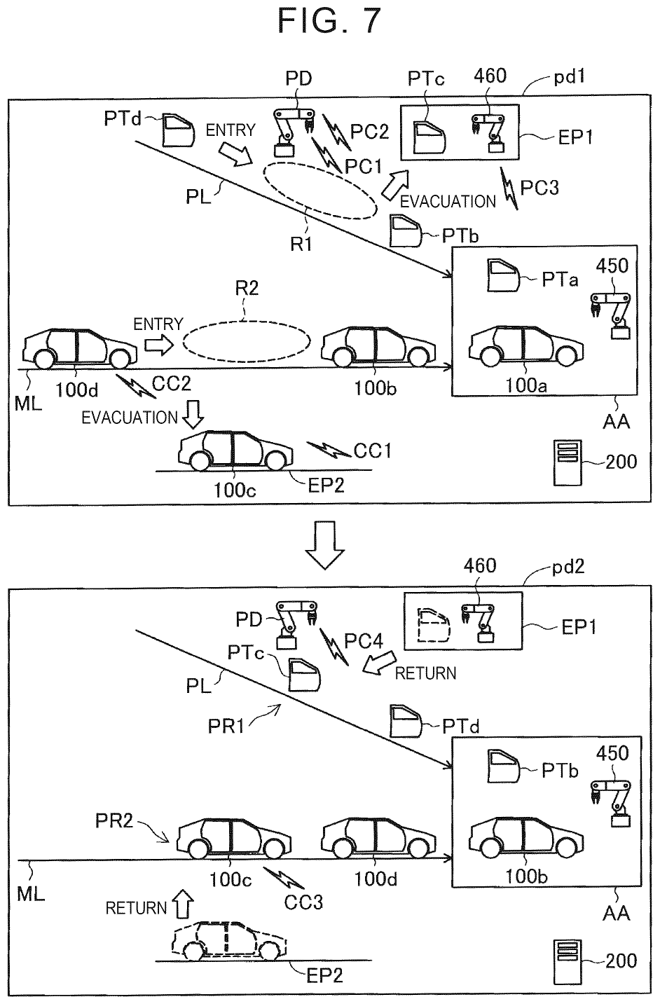

FIG. 7 is a diagram illustrating an example of a manufacturing process. FIG. 7 shows an exemplary case in which the component PTc is a defective component and the vehicle 100c is a corresponding vehicle. In FIG. 7, the trailing component PT of the component PTd and the trailing vehicle 100 of the vehicle 100d are omitted. In the term pd1 of FIG. 7, the assembly of the component PTa to the vehicle 100a is performed in the assembly area AA. Further, in the term pd1, a component evacuation instruction PC1, a component entry instruction PC2, a repair instruction PC3, a vehicle evacuation instruction CC1, and a vehicle entry instruction CC2 are issued. The period pd2 is a period that is temporally later than the period pd1, and specifically, a period after the repair of the defect of the component PTc is completed. In the term pd2, the assembly of the component PTb to the vehicle 100b is performed in the assembly area AA. In the term pd2, the component return instruction PC4 and the vehicle return instruction CC3 are issued.

In the term pd1, the component PTc, which is a defective component, is evacuated from the component line PL to the first evacuation location EP1 by the component evacuation instruction PC1. Consequently, in the component line PL, a first vacant region R1 is generated between the component PTb preceding the component PTd and the component PTd as the trailing component. The component entry instruction PC2 causes the component PTd to enter the first vacant region R1. The repair device 460 to which the repair instruction PC3 is issued repairs the defect of the component PTc. Further, by the vehicle evacuation instruction CC1, the vehicle 100c, which is the corresponding vehicle, is evacuated from the manufacturing line ML to the second evacuation location EP2. Consequently, in the manufacturing line ML, a second vacant region R2 is generated between the vehicle 100b which is the preceding vehicle and the vehicle 100d which is the trailing vehicle. The vehicle entry instruction CC2 causes the vehicle 100d to enter the second vacant region R2.

In the term pd2, by the component return instruction PC4, the component PTc that is the repaired component is moved from the first evacuation location EP1 to the component line PL, and returns to the component line PL in the first return position PR1. In FIG. 7, the returned component PTc is located behind the component PTd in the component line PL. By the vehicle return instruction CC3, the vehicle 100c, which is the corresponding vehicle, travels from the second evacuation location EP2 to the manufacturing line ML, and returns to the manufacturing line ML at the second return position PR2. In FIG. 7, the returned vehicle 100c is located behind the vehicle 100d in the manufacturing line ML. After the term pd2, the vehicle 100d and the component PTd usually arrive at the assembly area AA, and thereafter, the returned vehicle 100c and the returned component PTc arrive at the assembly area AA. Then, in the assembly area AA, after the assembly of the component PTb to the vehicle 100b is completed, the assembly of the component PTd to the vehicle 100d and the assembly of the component PTc to the vehicle 100c are sequentially executed.

According to the server 200 in the present embodiment described above, a vehicle evacuation instruction for evacuating the corresponding vehicle corresponding to the defective component evacuated from the component line PL from the manufacturing line ML by the unmanned operation is issued. Therefore, it is possible to prevent the wrong component PT from being assembled to the vehicles 100 in the assembly area AA. More specifically, for example, it is possible to prevent a component PT having an incorrect vehicle type, color/grade from being assembled to the vehicle 100. As described above, according to the present embodiment, it is possible to appropriately perform the assembly in the assembly area AA.

Further, in the present embodiment, a component entry instruction instructing to enter a trailing component into the first vacant region RI and a vehicle entry instruction instructing to enter a trailing vehicle into the second vacant region R2 are issued. Therefore, since the vehicles 100 can be efficiently moved in the manufacturing line ML and the component PT can be efficiently moved in the component line PL, the assembly can be performed more efficiently in the assembly area AA. In addition to allowing the trailing component to enter the first vacant region R1, the instruction unit 230 may issue an instruction to cause the trailing component PT of the trailing component to enter the vacant region generated by causing the trailing component to enter the first vacant region R1. In addition to causing the trailing vehicle to enter the second vacant region R2, the instruction unit 230 may issue an instruction to enter the vacant region generated by causing the trailing vehicle to enter the second vacant region R2 and an instruction to enter the further trailing vehicle 100 of the trailing vehicle.

In the present embodiment, in the vehicle entry instruction, the degree of deceleration of the trailing vehicle is made smaller than the degree of deceleration of the preceding vehicle, so that the trailing vehicle enters the second vacant region R2. In this way, the velocity of the vehicle 100 in the assembling or inspecting process performed upstream of the assembly area AA in the manufacturing line ML can be reduced, for example, as compared with the case where the vehicle enters the second vacant region R2 by further accelerating the trailing vehicle. As a result, for example, it is possible to suppress an excessively short time allocatable to the work process and a speed of the vehicle 100 from becoming higher than a speed suitable for the work process, and it is possible to suppress an influence caused by the speed of the vehicle 100 being higher in the work process. In addition, energy required for acceleration can be saved.

Further, in the present embodiment, when the repair of the defective component is completed, a component restoration instruction is issued to the component processor PD for the repaired component. Further, a vehicle return instruction for causing the corresponding vehicle to enter the manufacturing line ML by an unmanned operation is issued to the evacuated corresponding vehicle. In this way, the repaired component can be restored to the component line PL and the corresponding vehicles can be restored to the manufacturing line ML without manual operation. Consequently, the component line PL and the manufacturing line ML can be used to join the repaired component and the corresponding vehicle in the assembly area AA, and the repaired component can be assembled to the corresponding vehicle.

### B. Second Embodiment

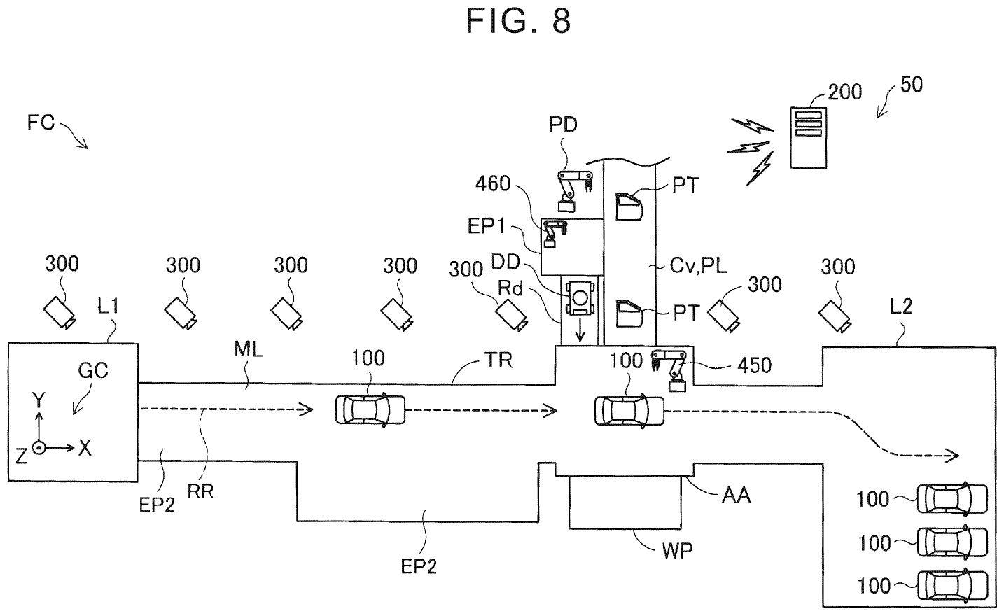

FIG. 8 is a block diagram illustrating a configuration of the system 50 according to the second embodiment. In the present embodiment, unlike the first embodiment, the instruction unit 230 executes a skip instruction in place of the vehicle evacuation instruction. Further, in the present embodiment, when the repair of the defect of the defective component is completed, the instruction unit 230 executes the delivery instruction and the assembly instruction in place of the part entry instruction and the vehicle entry instruction. Other configurations are the same as those of the first embodiment unless otherwise specified.

The skip instruction is an instruction for skipping the assembly of the corresponding component. For example, the skip instruction is issued to at least one of a device that performs assembly in the assembly area AA, an operator that performs assembly in the assembly area AA, and an administrator. In the present embodiment, the instruction unit 230 issues a skip instruction to the assembly robot 450. In the skip instruction in the present embodiment, the instruction unit 230 transmits a control command for skipping the assembly of the corresponding component to the assembly robot 450.

In the present embodiment, the instruction unit 230 issues a standby instruction together with a skip instruction. The standby instruction is an instruction for causing the corresponding vehicles to be skipped in assembly to stand by in the standby location WP. In the present embodiment, the standby instruction is an instruction for causing the corresponding vehicles to travel from the assembly area AA to the standby location WP by unmanned driving and to standby at the standby location WP. Specifically, the standby instruction is a travel control signal for causing the corresponding vehicles to travel to the standby location WP and to be stopped at the standby location WP. In the present embodiment, the standby location WP is disposed in the vicinity of the assembly area AA. In another embodiment, the standby instruction may instruct, for example, a device or a worker configured to move the corresponding vehicle from the assembly area AA to the standby location WP to move the corresponding vehicle from the assembly area AA to the standby location WP.

The delivery instruction is an instruction for moving the repaired component toward the corresponding vehicle using a device other than the component line PL. The delivery instruction is executed for the delivery device DD. The delivery device DD is a device configured to be able to move repaired components toward the vehicles 100. In the present embodiment, the delivery device DD is configured by a AGV capable of traveling in an area outside the component line PL, specifically, in the road Rd. The road Rd connects the assembly area AA and the second evacuation location EP2 as a repair location outside the component line PL. In the delivery instruction, the instruction unit 230 transmits a control signal for moving the repaired component from the second evacuation location EP2 toward the assembly area AA to the delivery device DD. In other embodiments, the delivery device DD may be, for example, a cart or a drone.

The assembling instruction is an instruction for assembling the repaired component to the corresponding vehicle. In the present embodiment, the assembling instruction is an instruction for assembling the repaired component to the corresponding vehicles in the assembly area AA. For example, the assembling instruction is issued to at least one of the equipment that performs the assembling in the assembly area AA and the worker. In the present embodiment, the instruction unit 230 issues an assembly instruction to the assembly robot 450. Specifically, in the assembling instruction, the instruction unit 230 transmits, for example, a control command for assembling the delivered repaired component to the corresponding vehicle that has waited for the standby location WP to the assembly robot 450. Upon receiving the control command, the assembly robot 450 holds the repaired component and assembles the repaired component to the corresponding vehicle. The instruction unit 230 may issue a standby release instruction for moving the corresponding vehicle from the standby location WP to the assembly area AA in response to the assembly instruction. The standby release instruction is, for example, an instruction obtained by replacing the standby location WP and the assembly area AA in the standby instruction.

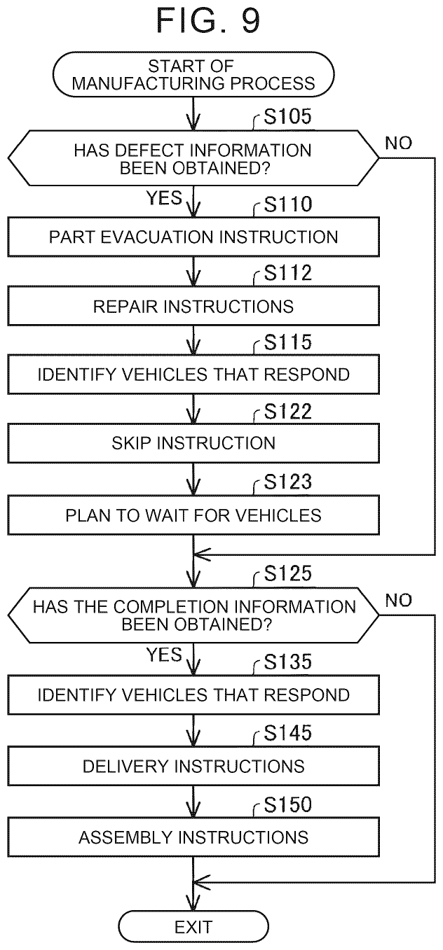

FIG. 9 is a flowchart of a manufacturing process for realizing the manufacturing method of the vehicle 100 according to the second embodiment. In the manufacturing process of FIG. 9, the same reference numerals are given to the same steps as those of the manufacturing process of FIG. 6. In the manufacturing process according to the present embodiment, the component entry instruction is not issued, but may be issued substantially in the same manner as in the first embodiment.

After S115, the instruction unit 230 issues an instruction to skip the corresponding vehicles identified by S115 to the assembly robot 450 in S122. The assembly robot 450 that has issued the skip instruction skips the assembling of the corresponding vehicle when the corresponding vehicle arrives at the assembly area AA. In S123, the instruction unit 230 takes a standby state in which it is scheduled to issue a standby instruction to the corresponding vehicles. Specifically, in the standby state, when the corresponding vehicle arrives at the assembly area AA, the instruction unit 230 issues a standby instruction to the corresponding vehicle. The corresponding vehicles to which the standby instruction is issued move to the standby location WP by the unmanned driving and are stopped. As a result, the trailing vehicle is usually assembled prior to the assembly of the corresponding vehicle. It should be noted that the arrival of the corresponding vehicle at the assembly area AA can be detected using, for example, the identification number of the corresponding vehicle. In this case, for example, the identification number of the component PT that arrives at the assembly area AA may be read by the assembly robot 450 or the detector, and the read identification number and the identification number of the corresponding component may be checked. The identification number of the corresponding component may be transmitted from the terminal device 380 or the server 200 to the assembly robot 450 or the detector, for example. For example, a two-dimensional code or an RFID (Radio Frequency Identification) may be used to read the identification number.

In the present embodiment, when the completion data is acquired by S125, S135 is executed without executing S130. After S135, at S145, the instruction unit 230 issues a delivery instruction to the delivery device DD. The delivery device DD to which the delivery instruction is issued moves the repaired component from the first evacuation location EP1 toward the vehicle 100, more specifically, toward the assembly area AA, by traveling on the road Rd while holding the repaired component. In S150, the instruction unit 230 issues an assembling instruction to the assembly robot 450. The assembly instruction may be executed prior to the repaired component arriving at the assembly area AA, or may be executed after the repaired component arrives. When a repaired component arrives at the assembly area AA, the assembly robots 450 to which the assembly instruction has been executed assemble the repaired component to the corresponding vehicles. Note that the arrival of the repaired component at the assembly area AA can be detected using the identification number of the repaired component, for example, substantially the same as when the arrival of the corresponding vehicle is detected.

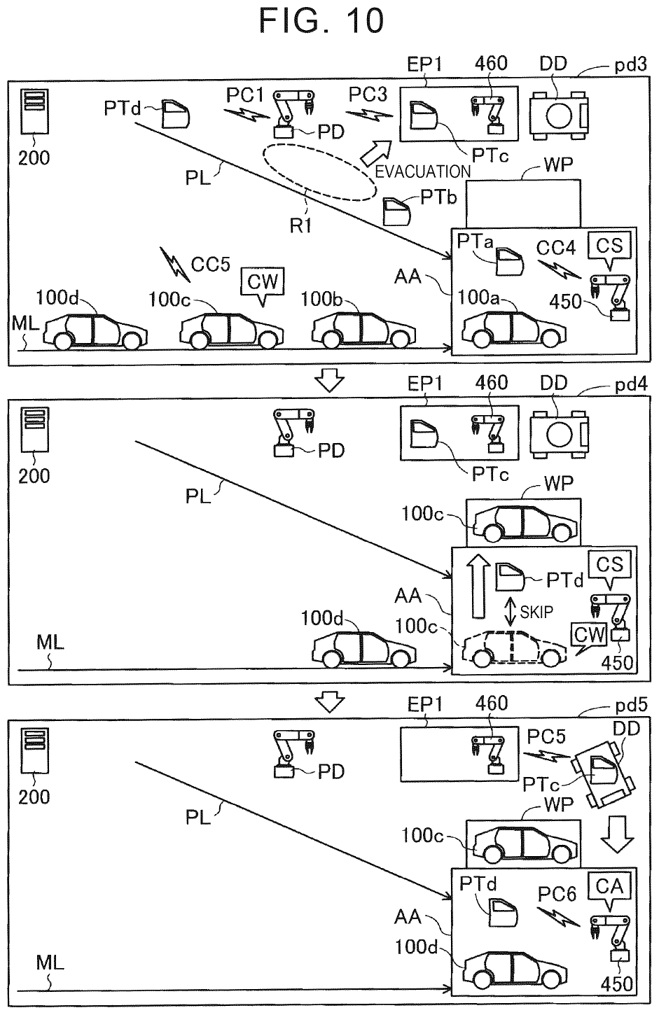

FIG. 10 is a diagram illustrating an example of a manufacturing process. FIG. 10 shows an exemplary case in which the component PTc is a defective component and the vehicle 100c is a corresponding vehicle, similarly to FIG. 7. FIG. 10 shows the state of each vehicle 100 and each component PT in the period pd3, the period pd4, and the period pd5. The period pd4 is a period that is temporally later than the period pd3. The period pd5 is a period that is temporally later than the period pd4. The period pd5 is a period after the repair of the component PTc is completed.

In the term pd3, the assembly of the component PTa to the vehicle 100a is performed in the assembly area AA. Further, in the term pd3, the component evacuation instruction PC1, the repair instruction PC3, and the skip instruction CC4 are issued. The component evacuation instruction PC1 and the repair instruction PC3 are the same as those of the first embodiment. By the skip instruction CC4, the assembly robots 450 take the skip state CS. The skip state CS is a state in which the assembly robots 450 are scheduled to skip the assembly of the corresponding vehicles. In addition, the servers 200 take standby status CW in response to the skip-instruction CC4.

The period pd4 is a period after the assembly of the component PTb to the vehicle 100b is completed, and is a period after the vehicle 100c and the component PTd arrive at the assembly area AA. In the term pd2, the assembly robots 450 in the skip state CS skip the assembly of the corresponding vehicles. Further, the servers 200 in the standby status CW issue standby instruction CC5 to the corresponding vehicles. By the standby instruction CC5, the corresponding vehicles move to the standby location WP.

In the term pd5, the vehicle 100d has arrived at the assembly area AA. In the term pd3, the delivery instruction PC5 and the assembly instruction PC6 are executed. The delivery instruction PC5 causes the delivery device DD to move the component PTc, which is the repaired component, toward the vehicle 100d to the assembly area AA. The assembly instruction PC6 causes the assembly robots 450 to take the assembly state CA. The assembly state CA is a state in which the assembly robots 450 are scheduled to assemble the repaired components to the corresponding vehicles. After the duration pd5, when the component PTc arrives at the assembly area AA, the assembly robot 450 in the assembly state CA assembles the arrived component PTc to the vehicle 100c.

According to the server 200 of the present embodiment described above, a skip instruction for skipping the assembly of the corresponding vehicles corresponding to the defective components evacuated from the component line PL is issued. Therefore, according to the present embodiment as well, it is possible to prevent the incorrect component PT from being assembled to the vehicles 100 in the assembly area AA, and to appropriately perform the assembly.

Further, in the present embodiment, when the repair of the defective component is completed, a delivery instruction for moving the repaired component toward the corresponding vehicle using the delivery device DD and an assembly instruction for assembling the repaired component to the corresponding vehicle are issued. Therefore, the repaired components can be assembled to the corresponding vehicles in the assembly area AA without causing the repaired components to enter the component line PL again.

In other embodiments, the standby instruction may not be issued when the skip instruction is issued. In this case, the corresponding vehicle may continue to travel in the manufacturing line ML, for example, after the assembly is skipped in the assembly area AA. In this case, the delivery instruction may be, for example, an instruction to move the repaired component toward the corresponding vehicle traveling on the manufacturing line ML. Further, for example, when the associated vehicles in which the assembly is skipped are directed to the trailing area of the assembly area AA, the delivery instruction may be an instruction to move the repaired component toward the trailing area. C. third embodiment:

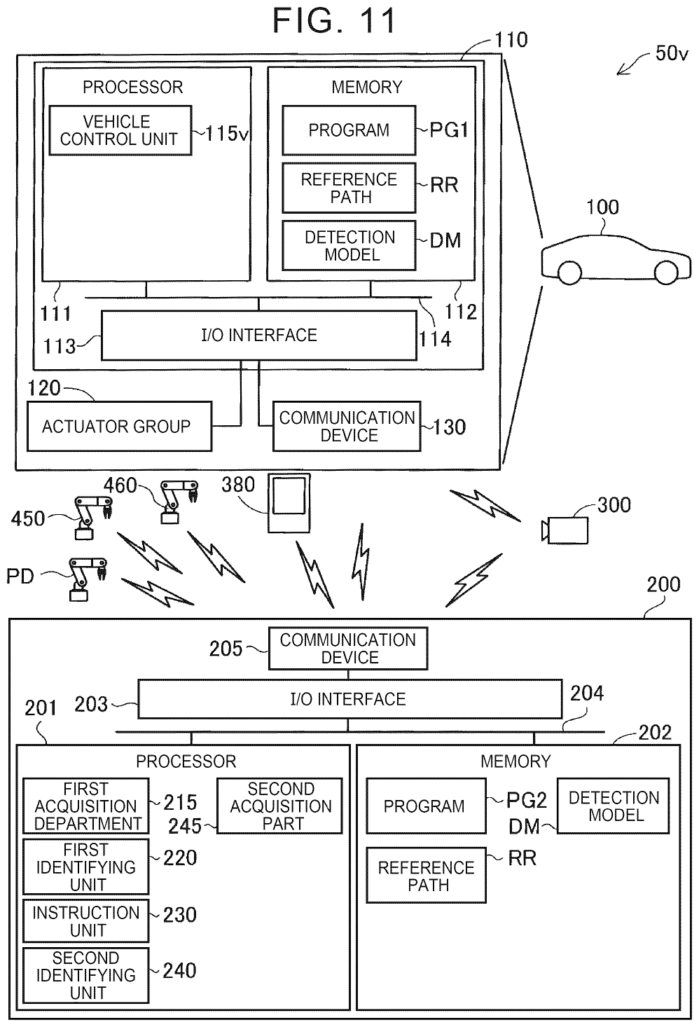

FIG. 11 is a diagram illustrating a configuration of a system 50v according to a third embodiment. The vehicle according to the present embodiment can travel by autonomous control of the vehicle. Other configurations are the same as those of the first embodiment unless otherwise specified. Since the device configuration of the vehicle in the present embodiment is the same as that of the vehicle 100 in the first embodiment, the vehicle in the present embodiment is also referred to as the vehicle 100 for convenience.

In the present embodiment, the communication device 130 of the vehicle 100 can communicate with the external sensor 300. The processor 111 of the vehicle control device 110 functions as a vehicle control unit 115v by executing a program PG2 stored in the memory 112. In the present embodiment, the instruction unit 230 does not generate the travel control signal. The vehicle control unit 115v controls the actuator group 120 by using the travel control signal generated by the vehicle 100, so that the vehicle 100 can travel by autonomous control. In addition to the program PG1, the memory 112 stores a reference path RR and detection model DM.

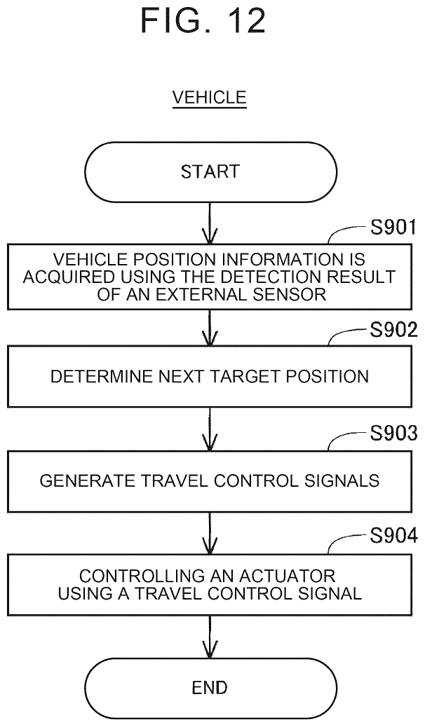

FIG. 12 is a flowchart illustrating a processing procedure of travel control of the vehicle 100 according to the third embodiment. In the process of FIG. 12, the processor 111 of the vehicle 100 functions as the vehicle control unit 115v by executing the program PG1.

In S901, the processor 111 of the vehicle control device 110 acquires the vehicle position information using the detection result outputted from the camera as the external sensor 300. In S902, the processor 111 determines a target position to which the vehicles 100 should be heading next. In S903, the processor 111 generates a travel control signal for causing the vehicles 100 to travel toward the determined target position. In S904, the processor 111 controls the actuator group 120 using the generated travel control signal to cause the vehicles 100 to travel in accordance with the parameters represented by the travel control signal. The processor 111 repeats acquisition of vehicle position information, determination of a target position, generation of a travel control signal, and control of an actuator at a predetermined cycle. According to the system 50v of the present embodiment, the vehicle 100 can be caused to travel by autonomous control of the vehicle 100 without remotely controlling the vehicle 100 by the servers 200.

The manufacturing method of the vehicle 100 according to the present embodiment is realized by a manufacturing process similar to that of FIG. 6. However, in the present embodiment, the vehicle evacuation instruction of S120 is an instruction for evacuating the corresponding vehicle from the manufacturing line ML by autonomous control, and is, for example, an instruction for setting the destination of the corresponding vehicle to the second evacuation location EP2. Further, the vehicle return instruction of S140 is an instruction for returning the corresponding vehicle from the manufacturing line ML by autonomous control, and is, for example, an instruction for setting the destination of the corresponding vehicle to the second return position PR2 on the manufacturing line ML.

The above-described servers 200 according to the present embodiment can also prevent incorrect component PT from being assembled to the vehicles 100 in the assembly area AA. Therefore, the assembly in the assembly area AA can be appropriately performed. In other embodiments, when the vehicle 100 is configured to be able to travel by autonomous control, for example, a skip instruction may be executed in the same manner as in the second embodiment. That is, the method of manufacturing the vehicle 100 may be realized by, for example, a manufacturing process similar to that of FIG. 9. D. other embodiments:
(D1) In each of the above-described embodiments, both the vehicle evacuation instruction and the skip instruction may be issued.
(D2) In the above-described embodiments, the component evacuation instruction is executed for the component processor PD capable of evacuating the component PT from the component line PL. On the other hand, the component evacuation instruction may be executed for the user, for example, a conveyor device Cv as a device capable of evacuating the component PT from the component line PL instead of the component processor PD. The user may be, for example, an administrator or an operator capable of evacuating the component PT. The component evacuation instruction to the user may be issued to the terminal device 380.
(D3) In each of the above-described embodiments, the deceleration of the trailing vehicle with respect to the preceding vehicle is suppressed in the vehicle entry instruction, but it is not necessary to do so. For example, in the vehicle entry instruction, the trailing vehicle may enter the second vacant region R2 by accelerating the trailing vehicle. In addition, the vehicle entry instruction may be realized by, for example, an instruction for executing group control for keeping the inter-vehicle distance between the front and rear vehicles 100 substantially constant.
(D4) In the first embodiment, the component entry instruction is executed, but the component entry instruction may not be executed. In addition, the vehicle entry instruction may not be executed substantially in the same manner.
(D5) In each of the above-described embodiments, the repair instruction is executed, but the repair instruction may not be executed. If the repair instruction is not performed, the defective component may be disassembled or discarded without being repaired, for example. That is, in this case, the component return instruction and the delivery instruction may not be issued. In addition, a new component PT adapted to the corresponding vehicle may be assembled to the corresponding vehicle. Further, in this case, the corresponding vehicle may be disassembled or discarded without performing the assembly of the corresponding vehicle.
(D6) In each of the above-described embodiments, for example, a part evacuate instruction, a vehicle evacuation instruction, a part entry instruction, a vehicle entry instruction, a repair instruction, a part return instruction, a vehicle return instruction, and a part or all of the standby instruction may be issued by separate functional units for issuing the respective instructions. For example, each process may be executed by a component evacuation instruction unit, a vehicle evacuation instruction unit, a component entry instruction unit, a vehicle entry instruction unit, a repair instruction unit, a component return instruction unit, a vehicle return instruction unit, and a standby instruction unit, respectively. In this case, the functional unit in which the functional units are combined corresponds to the “instruction unit” in the present disclosure.

(D7) In each of the above-described embodiments, the server 200 includes a first acquisition unit 215, a second identifying unit 240, and a second acquisition unit 245. On the other hand, some or all of the server 200, the first acquisition unit 215, the second identifying unit 240, and the second acquisition unit 245 may not be provided. In this case, a device other than the server 200, for example, the component processor PD, the assembly robots 450, and the repair devices 460 may include the first acquisition unit 215, the second identifying unit 240, and the second acquisition unit 245.
(D8) In the second embodiment, the vehicle 100 may include some or all of the functional units included in the server 200. For example, the vehicle 100 may include the first identifying unit 220 and the instruction unit 230. In this case, the vehicle 100 corresponds to a “device” in the present disclosure. In this case, the server 200 may be omitted. The vehicle 100 may include a first acquisition unit 215, a second acquisition unit 245, and a second identifying unit 240.
(D9) In each of the above-described embodiments, the external sensor 300 is not limited to a camera, and may be, for example, a distance measuring device. The distance measuring device is, for example, a LiDAR (Light Detection and Ranging). In this case, the detection result output by the external sensor 300 may be three-dimensional point cloud data representing the vehicle 100. In this case, the server 200 or the vehicle 100 may acquire the vehicle position information by template matching using three-dimensional point cloud data as a detection result and reference point cloud data prepared in advance.
(D10) In the first embodiment, the server 200 executes processing from acquisition of vehicle position information to generation of a travel control signal. On the other hand, at least a part of the processing from the acquisition of the vehicle position information to the generation of the travel control signal may be executed by the vehicle 100. For example, the following aspects (1) to (3) may be used.
(1) The server 200 may acquire the vehicle position information, determine a target position to which the vehicle 100 should be heading next, and generate a route from the current position of the vehicle 100 represented by the acquired vehicle position information to the target position. The server 200 may generate a route to a target position between the current location and the destination, or may generate a route to the destination. The server 200 may transmit the generated route to the vehicle 100. The vehicle 100 may generate a travel control signal so that the vehicle 100 travels on the route received from the server 200, and control the actuator group 120 using the generated travel control signal.
(2) The server 200 may acquire the vehicle position information and transmit the acquired vehicle position information to the vehicle 100. The vehicle 100 may determine a target position to which the vehicle 100 should be directed next, generate a route from the current position of the vehicle 100 represented by the received vehicle position information to the target position, generate a travel control signal so that the vehicle 100 travels on the generated route, and control the actuator group 120 using the generated travel control signal.
(3) In the above aspects (1) and (2), an internal sensor may be mounted on the vehicle 100, and a detection result output from the internal sensor may be used for at least one of generation of a route and generation of a travel control signal. The internal sensor is a sensor mounted on the vehicle 100. Specifically, the inner sensor may include, for example, a camera, a LiDAR, a millimeter-wave radar, an ultrasonic sensor, a GPS sensor, an accelerometer, a gyroscope, and the like. For example, in the aspect (1), the server 200 may acquire the detection result of the internal sensor and reflect the detection result of the internal sensor in the path when generating the path. In the aspect (1), the vehicle 100 may acquire the detection result of the internal sensor and reflect the detection result of the internal sensor in the travel control signal when generating the travel control signal. In the aspect (2), the vehicle 100 may acquire the detection result of the internal sensor and reflect the detection result of the internal sensor in the path when generating the path. In the aspect (2), the vehicle 100 may acquire the detection result of the internal sensor and reflect the detection result of the internal sensor in the travel control signal when generating the travel control signal.
(D11) In the third embodiment, an internal sensor may be mounted in the vehicle 100, and a detection result output from the internal sensor may be used for at least one of generation of a route and generation of a travel control signal. For example, the vehicle 100 may acquire the detection result of the internal sensor and reflect the detection result of the internal sensor on the route when generating the route. The vehicle 100 may acquire the detection result of the internal sensor and reflect the detection result of the internal sensor in the travel control signal when generating the travel control signal.
(D12) In the third embodiment, the vehicle 100 acquires the vehicle position information using the detection result of the external sensor 300. On the other hand, an internal sensor may be mounted on the vehicle 100, and the vehicle 100 may acquire vehicle position information using a detection result of the internal sensor, determine a target position to which the vehicle 100 should be directed next, generate a route from the current position of the vehicle 100 represented by the acquired vehicle position information to the target position, generate a travel control signal for traveling on the generated route, and control the actuator group 120 using the generated travel control signal. In this case, the vehicle 100 can travel without using any detection result of the external sensor 300. Note that the vehicle 100 may acquire the target arrival time and the traffic jam information from the outside of the vehicle 100 and reflect the target arrival time and the traffic jam information on at least one of the route and the travel control signal. In addition, all of the functional configurations of the system 50v may be provided in the vehicle 100. That is, the process implemented by the system 50v may be implemented by the vehicles 100 alone.
(D13) In the first embodiment, the server 200 automatically generates a travel control signal to be transmitted to the vehicle 100. On the other hand, the server 200 may generate a travel control signal to be transmitted to the vehicle 100 in accordance with an operation of an external operator located outside the vehicle 100. For example, an external operator may operate a control device including a display for displaying a captured image output from the external sensor 300, a steering for remotely controlling the vehicle 100, an accelerator pedal, a brake pedal, and a communication device for communicating with the server 200 through wired communication or wireless communication, and the server 200 may generate a travel control signal corresponding to an operation applied to the control device.
(D14) The vehicle 100 may be manufactured by combining a plurality of modules. A module refers to a unit composed of one or more components grouped according to the configuration and function of the vehicle 100. For example, the platform of the vehicle 100 may be manufactured by combining a front module that constitutes a front portion of the platform, a central module that constitutes a central portion of the platform, and a rear module that constitutes a rear portion of the platform. The number of modules constituting the platform is not limited to three, and may be two or less or four or more. In addition to or instead of the platform, a different part of the vehicle 100 from the platform may be modularized. Further, the various modules may include any exterior parts such as bumpers and grills, and any interior parts such as sheets and consoles. In addition, not only the vehicle 100 but also a moving body of an arbitrary mode may be manufactured by combining a plurality of modules. Such a module may be manufactured, for example, by joining a plurality of parts by welding, a fixture, or the like, or may be manufactured by integrally molding at least a part of the module as one part by casting. Molding techniques for integrally molding at least a portion of a module as one part are also referred to as gigacasting or megacasting. By using gigacasting, each part of the moving body, which has been conventionally formed by joining a plurality of parts, can be formed as one part. For example, the front module, the central module, and the rear module described above may be manufactured using gigacasting.
(D15) Transporting the vehicle 100 by using the traveling of the vehicle 100 by the unmanned driving is also referred to as “self-propelled conveyance”. A configuration for realizing self-propelled conveyance is also referred to as a “vehicle remote control autonomous traveling conveyance system”. Further, a production method of producing the vehicle 100 by using self-propelled conveyance is also referred to as “self-propelled production”. In self-propelled manufacturing, for example, at least a part of conveyance of the vehicle 100 is realized by self-propelled conveyance in a factory FC that manufactures the vehicle 100.

In each of the above-described embodiments, some or all of the functions and processes implemented in software may be implemented in hardware. In addition, some or all of the functions and processes implemented in hardware may be implemented in software. For example, various circuits such as an integrated circuit and a discrete circuit may be used as hardware for realizing various functions in the above-described embodiments.

What is claimed is:

1. A device comprising:
an identifying unit that identifies, out of one or more moving bodies that move over a manufacturing line by unmanned driving, a relevant moving body to which a defective component that was evacuated from a component line, over which a plurality of components flows, is to be assembled, in which the component line merges with the manufacturing line in an assembly area for executing assembly of the component to the moving body; and
an instruction unit for issuing at least one of an evacuation instruction for evacuating the relevant moving body from the manufacturing line by the unmanned driving, and a skip instruction for skipping the assembling to the relevant moving body.

2. The device according to claim 1, wherein when the evacuation instruction is issued, the instruction unit issues
a first entry instruction for instructing equipment that is configured to change a position of each of the components flowing over the component line, to cause to enter, into a first vacant region generated by the defective component being removed from the component line, the component trailing the defective component, and
a second entry instruction for instructing a trailing moving body that is the moving body trailing the relevant moving body, to enter a second vacant region generated by the relevant moving body being removed from the manufacturing line.

3. The device according to claim 2, wherein the instruction unit causes the trailing moving body to enter the second vacant region by making a degree of deceleration of the trailing moving body to be smaller than a degree of deceleration of the moving body preceding the trailing moving body, in the second entry instruction.

4. The device according to claim 1, wherein the instruction unit
issues an instruction to repair a defect of the defective component that was evacuated, and
when repair of the defect is complete, issues
an instruction for causing equipment that is configured to enter a repaired component that is the component regarding which the repair is completed to the component line, to enter the repaired component to the component line, and
an instruction for causing the relevant moving body evacuated by the evacuation instruction to enter the manufacturing line by the unmanned driving.

5. The device according to claim 1, wherein the instruction unit
issues an instruction to repair a defect of the defective component that was evacuated, and
when repair of the defect is complete, issues
an instruction for moving a repaired component that is the component regarding which the repair is completed, toward the relevant moving body using a device different from the component line, and
an instruction for assembling the repaired component to the relevant moving body.
